(19) United States
(12) Patent Application Publication
(10) Pub. No.: US 2024/0181667 A1
(43) Pub. Date: Jun. 6, 2024

(54) CUTTING APPARATUS AND METHOD FOR CAPSULES

(71) Applicant: SACMI COOPERATIVA MECCANICI IMOLA SOCIETA’ COOPERATIVA, Imola (BO) (IT)

(72) Inventors: Fabrizio VILLA, Imola (BO) (IT); Riccardo LANZONI, Castel Bolognese (RA) (IT); Maurizio SCARANARO, Casalfiumanese (BO) (IT)

(21) Appl. No.: 18/546,646

(22) PCT Filed: Feb. 16, 2022
(86) PCT No.: PCT/IB2022/051362

§ 371 Date: Aug. 16, 2023

(30) Foreign Application Priority Data
Feb. 17, 2021 (IT) 102021000003656
Feb. 7, 2022 (IT) 102022000002165

(51) Int. Cl. B26D 5/00; B26D 1/02; B26D 7/01

(52) U.S. Cl. CPC B26D 5/007; B26D 1/02; B26D 7/018

(57) ABSTRACT

A cutting apparatus and method are disclosed for forming on a capsule a preferential cutting line that defines a guarantee band, with a feeding device configured to feed a respective capsule to a cutting arrangement, with a sensor unit that detects an orientation of the capsules before they reach the cutting arrangement, and a control device configured to vary an orientation of the capsule on the basis of the detection of the sensor unit before the capsule reaches the cutting arrangement.

### BACKGROUND OF THE INVENTION

The invention relates to a cutting apparatus and method, in particular for cutting capsules of containers, for example for capsules made of plastics and usable for closing containers, such as for example bottles.

Specifically, but not exclusively, the invention relates to cutting a side wall of a capsule to make a tamper ring, or guarantee band, intended to break at the first opening of the capsule.

In particular, reference is made to an apparatus made as in the preamble of the first claim. Such an apparatus is known, for example, from patent publication EP 3 103 603 A1.

Making a circumferential cut on a capsule by rolling the capsule on a fixed knife is known, to form, on one wall of the capsule, a preferential breaking line that defines the guarantee band.

In this respect, the prior art is improvable.

In particular, it is desirable to feed the capsule to the knife such that the capsule, when it comes into contact with the knife, is oriented in an appropriate manner with respect to the knife, in particular if it is necessary to make a cut along a wall of the capsule for less than 360°, i.e. not for a complete circumference, to start and conclude cutting the wall at two desired points.

### SUMMARY OF THE INVENTION

One object of the invention is to provide an apparatus and/or a method for cutting capsules for containers that are alternative to known containers.

One object is to solve the aforesaid problem of the prior art.

One object is to permit cutting of capsules for containers that is suitable for making with precision a tamper ring on the capsule.

One object is to facilitate cutting of “tethered” capsules, i.e. capsules that remain attached to the container after opening.

One advantage is to provide a constructionally simple and cheap apparatus for cutting capsules for containers.

One advantage is to permit the precise execution of one or more cuts on a wall of a capsule at set points of the wall.

In one embodiment, a cutting apparatus includes a rotatable carousel, two or more feeding units rotated by the carousel to feed the capsules to a cutting arrangement, and a sensor unit for detecting an orientation of each capsule before the capsule reaches the cutting arrangement, each feeding unit including a lower support to carry a capsule and an upper spindle that engages the capsule whilst the capsule rolls on the cutting arrangement, each lower support being susceptible of rotation around a rotation axis thereof and being configured to receive a rotation motion from a motor unit so as to vary an orientation of the capsule on the basis of the detection of the sensor unit.

### SHORT DESCRIPTION OF THE DRAWINGS

The invention can be better understood and implemented with reference to the attached drawings that illustrate some embodiments thereof by way of non-limiting example, in which:

FIG. 1 is a section in a vertical elevation is a first embodiment of an apparatus made according to the present invention;

FIG. 2 shows an enlarged detail of the apparatus of FIG. 1;

FIG. 3 is a section in a vertical elevation of a second embodiment of an apparatus made according to the present invention;

FIG. 4 shows an enlarged detail of the apparatus of FIG. 3;

FIG. 5 shows another enlarged detail of the apparatus of FIG. 3;

FIG. 6 shows a yet more enlarged detail of FIG. 4;

FIG. 7 is a section in a vertical elevation of a third embodiment of an apparatus made according to the present invention;

FIG. 8 is a plan view of one of the aforesaid embodiments of apparatus;

FIG. 9 is a plan view of a fourth embodiment of an apparatus made according to the present invention;

FIGS. 10 and 11 show profiles of the shape of the cam arrangement for guiding the support of the capsule translating in a vertical direction;

FIG. 12 is a plan view that shows some superimposed diagrams of apparatuses made according to the present invention;

FIGS. 13 and 14 are two sections in a vertical elevation of two embodiments of lower support for capsules that are usable in the aforesaid apparatuses;

FIG. 15 is a partially sectioned view in vertical elevation of a fifth example of an apparatus made in accordance with the present invention;

FIG. 16 is an enlarged detail of FIG. 15 showing a part of a power supply unit that includes an upper end of the respective spindle;

FIG. 17 is an enlarged detail of FIG. 15 showing a part of a feeding unit which includes the area where the capsule is engaged between the respective spindle and the respective support in a uncoupled operating configuration in which the support portion in contact with the capsule is uncoupled from the support portion which receives the rotational motion from the actuator device, so that the support portion in contact with the capsule does not receive the rotational motion;

FIG. 18 is an enlarged detail of FIG. 15 which shows the area of FIG. 17 in a coupling operating configuration in which the support portion in contact with the capsule receives the rotational motion from the actuator device through the engagement of a splined coupling;

FIG. 19 is an enlarged detail of FIG. 15 which shows a second version of the example of cutting apparatus in a uncoupled operating configuration similar to that of FIG. 17 in which the uncoupling device, adapted to release the support portion in contact with the capsule from the support portion which receives the rotational motion from the actuator device, is of the magnet type;

FIG. 20 is an enlarged detail of FIG. 15 showing the area of FIG. 19 in a coupling operating configuration;

FIG. 21 is a diagram illustrating a curve of the rotation speed of a rotor of the actuator device that activates the rotation of the support, as a function of the angular position of the capsule transport carousel around the carousel axis for a time corresponding to one revolution complete of the carousel, compared with a temporal sequence of operating phases of an example of a cycle of a cutting method in accordance with the present invention;

FIG. 22 is a diagram illustrating the angular position of the base (plate) supporting the capsule around the axis of rotation of the base, as a function of the angular position of the carousel around the carousel axis, in three cases different from each other depending on the initial (random) position of the capsule.

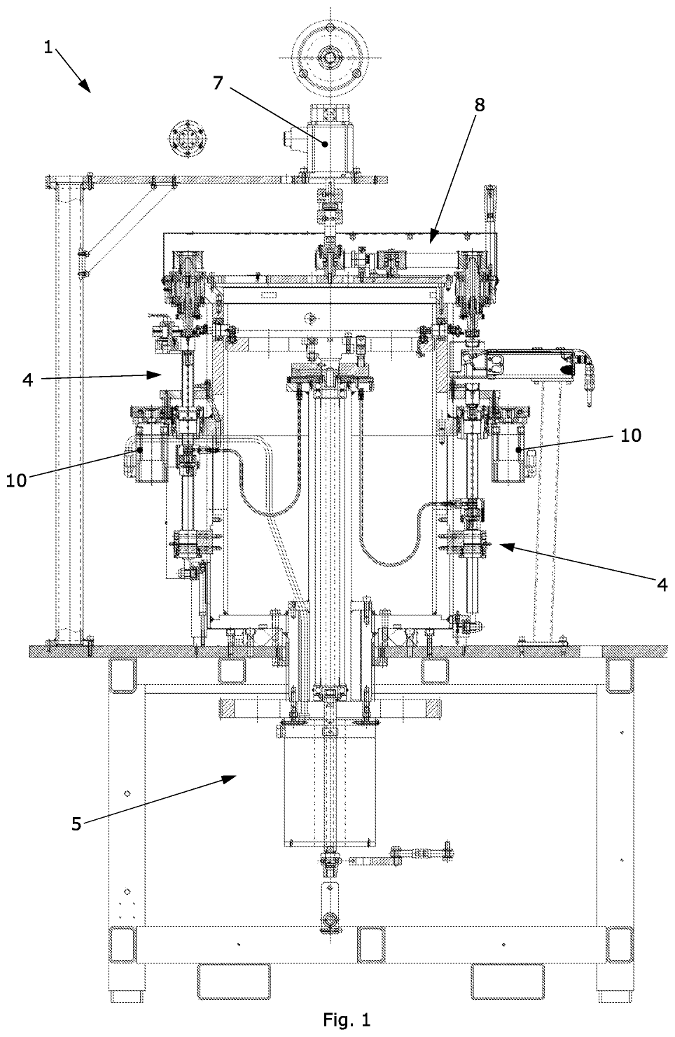

### DETAILED DESCRIPTION

With reference to the figures mentioned above, it is pointed out for the sake of simplicity that identical elements of different embodiments are indicated by the same reference number.

1 indicates overall a cutting apparatus for cutting capsules 2. The cutting apparatus 1 can be used, in particular, for cutting capsules 2 made of plastics and suitable for closing containers, like for example bottles. The cutting apparatus 1 can be used, in particular, for cutting a side wall of a capsule 2 to make a tamper ring, or guarantee band, intended to break the first opening of the capsule. The cutting apparatus 1 can be used, in particular, to make “tethered” capsules, i.e. capsules that remain attached to the container after opening.

The cutting apparatus 1 can include, in particular, a feeding device for feeding the capsules 2. The cutting apparatus 1 can include, in particular, a cutting arrangement 3 to make a guarantee band on each capsule 2 fed by the feeding device. The feeding device can include, in particular, one or more feeding units 4 each of which is movable along a path in which the cutting arrangement 3 is arranged. In some figures, the cutting arrangement 3 is not shown, for simplicity of representation, even if the cutting arrangement 3 is actually present in all the embodiments disclosed here. Each feeding unit 4 can be configured, in particular, to feed at least one capsule 2.

The cutting arrangement 3 can include, in particular, one or more blades or knives that are superimposed on one another and arranged along a portion of the (circumferential) path of the capsules 2 and can be configured to perform one or more cuts on the capsule. The cutting arrangement 3 can include, in particular, one or more vertical and/or oblique blades or knives configured, in particular, to make “tethered” capsules.

The feeding device can include, in particular, at least one carousel 5 that is rotatable around a carousel rotation axis. The carousel 5 can be, in particular, arranged for supporting the feeding units 4. The carousel rotation axis can be rotated by a motor unit (for example a motor of known type). Each feeding unit 4 can be, in particular, movable along a closed loop path, as in the specific embodiments in which the various feeding units 4 are arranged on the carousel 5 spaced angularly apart from one another. Each feeding unit 4 can include, in particular, a spindle 6 rotatable around a spindle rotation axis. The spindle 6 can be, in particular, configured to engage the capsule 2 whilst the capsule rolls on the cutting arrangement 3. The spindle 6 can be, in particular, configured to engage an inner surface of the capsule 2 facing upwards (as in the illustrated embodiments, in which each capsule 2 includes a skirt portion, or a side wall, closed by a closing wall arranged below and open above).

The cutting apparatus 1 can include, in particular, a motor unit 7 configured to rotate the spindle rotation axis when the spindle engages the capsule 2 whilst the capsule rolls on the cutting arrangement 3. The motor unit 7 that rotates the spindle rotation axis could be, in particular, the same motor unit configured to rotate the carousel rotation axis. The motor unit 7 that rotates the spindle rotation axis could be, in particular, adjusted according to a desired phasing in relation to a phasing of the motor unit configured to rotate the carousel rotation axis.

The cutting apparatus 1 can include, in particular, a motion transmitting arrangement 8 so configured that rotation of a rotation axis of the motor unit 7 causes, for each spindle, a rotation of the spindle rotation axis. The motion transmitting arrangement 8 can include, in particular, one or more flexible members arranged (on pulleys) to connect together the rotation axis of the motor unit 7 and the spindle rotation axis (as in the attached figures). In other embodiments the motion transmitting arrangement can include, in particular, a system with one or more gears (in addition to or in replacement of the aforesaid one or more flexible members), or a kinematic chain of another type.

Each feeding unit 4 can include, in particular, a support 9 rotatable around a support rotation axis. The support 9 can be, in particular, configured to engage the respective capsule 2 and to receive a rotation motion from an actuator device 10 configured to vary an orientation of the capsule 2 with respect to the support rotation axis before the capsule 2 reaches the cutting arrangement 3, so that the capsule 2 meets the cutting arrangement 3 with a desired orientation with respect to the cutting arrangement.

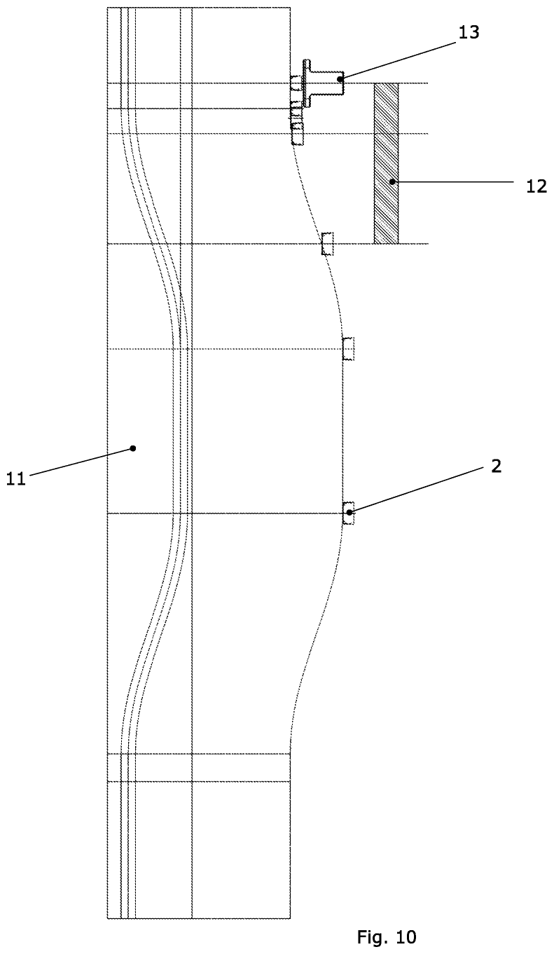

The support 9 can be, in particular (as in the embodiments disclosed here), configured to engage the capsule 2 by a suction retaining member (for example of known type). The support 9 can be configured, in particular, to engage an outer surface of the capsule 2 facing downwards (in particular the outer surface of the closing wall of the capsule arranged below). The support 9 can be, in particular (as in the embodiments disclosed here), susceptible to performing an axial (for example vertical) motion in both directions in relation to the respective spindle 6 so as to approach and move away from the respective spindle 6 (which can be fixed in a vertical direction). The axial motion of the support 9 can be, in particular (as in the embodiments disclosed here), guided by a cam arrangement. The cam arrangement can include, in particular, coupling between a fixed profile 11 and a movable tappet, in which the tappet is movable together with the support 9 (for example is integral with the support 9). The fixed profile 11 can, in particular, extend in a circumferential direction. In FIG. 10 an embodiment is shown of a profile of the shape 11 (extending on a plane) and of the respective path of a capsule 2 guided by the cam arrangement, considering a motion of the carousel 5 in one direction (for example clockwise). In FIG. 10, the motion of the capsule 2 is shown from top to bottom.

With 12 the path portion is shown in which the angular position (phasing) of the capsule can be adjusted by rotating (by the actuator device 10) the support 9 that carries the capsule 2 on the basis of the detection of the orientation of the capsule 2 performed by a sensor unit 13.

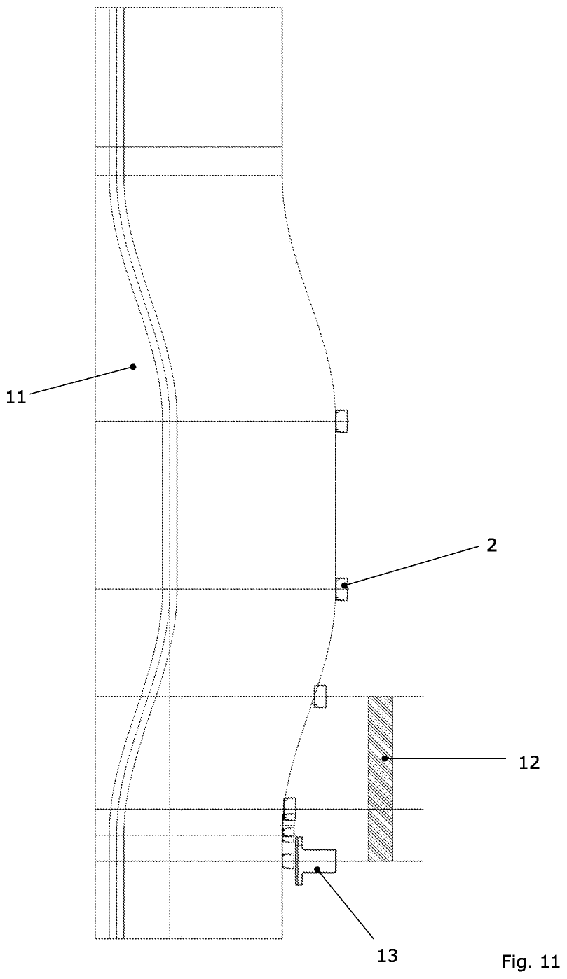

In FIG. 11, an embodiment is shown of a profile of the shape 11 (extending on a plane) and of the respective path of a capsule 2, considering a motion of the carousel 5 in an opposite direction (for example anticlockwise), so that the motion of the capsule 2 is shown from bottom to top.

The cutting apparatus 1 can include, in particular, at least one control unit that in turn can include, in particular, the aforesaid sensor unit 13 configured to detect an orientation of each capsule 2. The control unit can include, in particular, the aforesaid actuator device 10 configured to vary an orientation of a respective capsule 2. The control unit can include, in particular, a control device configured to control the actuator device 10 on the basis of detection of the sensor unit 13. The control device can include, in particular, an electronic and programmable control device (for example an electronic processor) and provided with computer instructions implemented on the programmable electronic device. The sensor unit 13 can include, in particular, an optical sensor unit, for example of the camera type. The sensor unit 13 can include, in particular, at least one sensor (camera), in particular fixed, arranged along the path travelled by the feeding units 4.

The control device can be configured, in particular, so as to be able to vary the orientation of each capsule 2 before the capsule reaches the cutting arrangement 3, so that the capsule 2 reaches the cutting arrangement 3 with a desired orientation with respect to the cutting arrangement 3 to start cutting in a desired point of the capsule 2. The actuator device 10 can include, in particular, for each feeding unit 4, at least one motor (for example an electric motor) arranged on the carousel 5, so as to be rotated by the carousel, and operationally associated with the respective rotatable support 9. For each feeding unit 4, the respective rotatable support (lower than the spindle 6) receives a rotation motion from the respective motor to vary the orientation of the capsule 2 and reach the desired angular position.

It is possible to provide embodiments provided with the aforesaid motion transmitting arrangement 8, so configured that whilst the capsule 2 rolls on the cutting arrangement 3 to perform the cutting, a rotation of the rotation axis of the motor unit 7 causes a rotation of each spindle rotation axis. The respective support can be, in particular, so configured that whilst the capsule 2 rolls on the cutting arrangement 3, the support rotation axis is fixed (with the capsule 2 that will slide with respect to the support 9 underneath) or in such a manner that, whilst the capsule 2 rolls on the cutting arrangement 3, the support rotation axis is rotatable in an idle manner (so that the capsule 2 might not slide with respect to the support 9 underneath).

It is possible to provide embodiments in which each feeding unit 4 is so configured that whilst the capsule 2 rolls on the cutting arrangement 3, the actuator device 10 (the corresponding motor of the feeding unit 4) drives the support rotation axis, whereas the spindle rotation axis is rotatable in an idle manner (for example without the arrangement of the aforesaid motion transmitting arrangement 8 to connect the spindle rotation axis to a driven rotation axis).

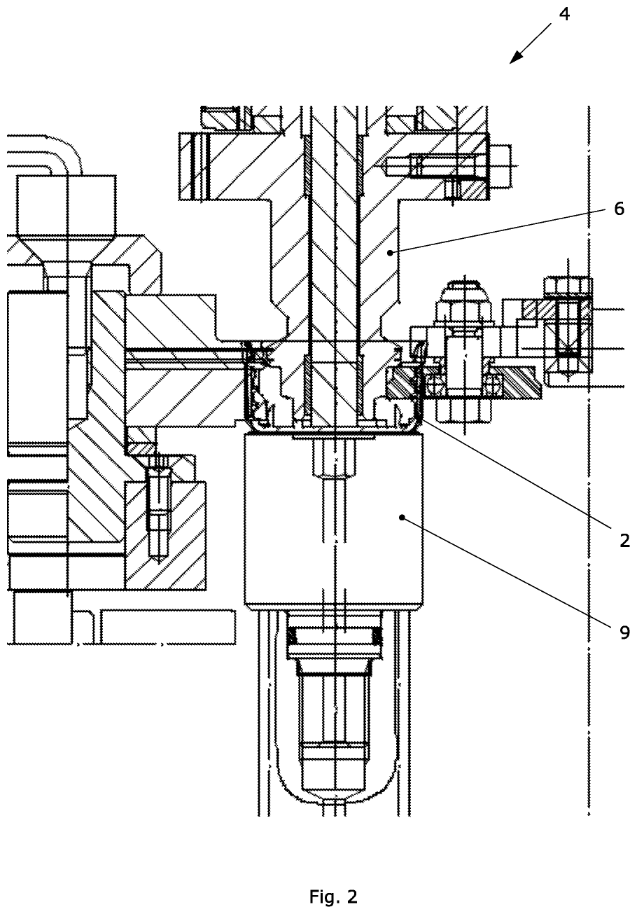

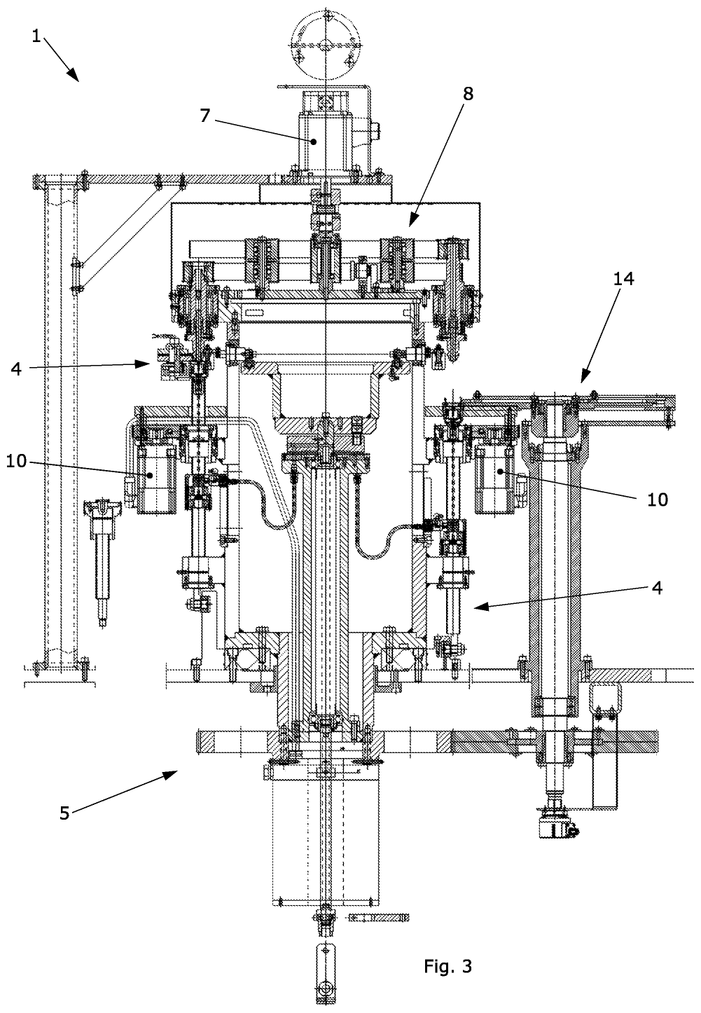

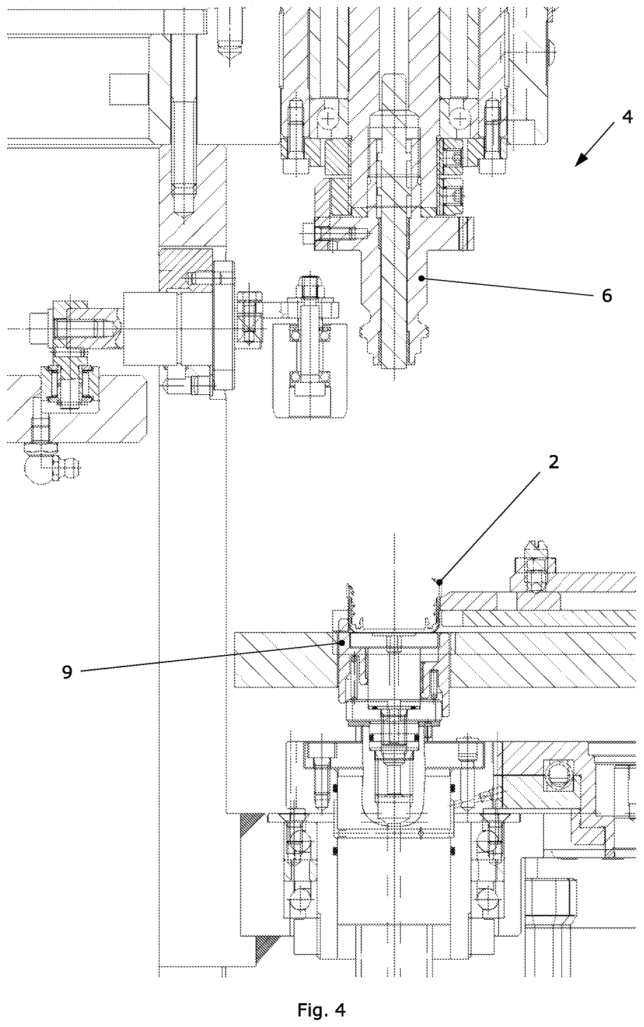

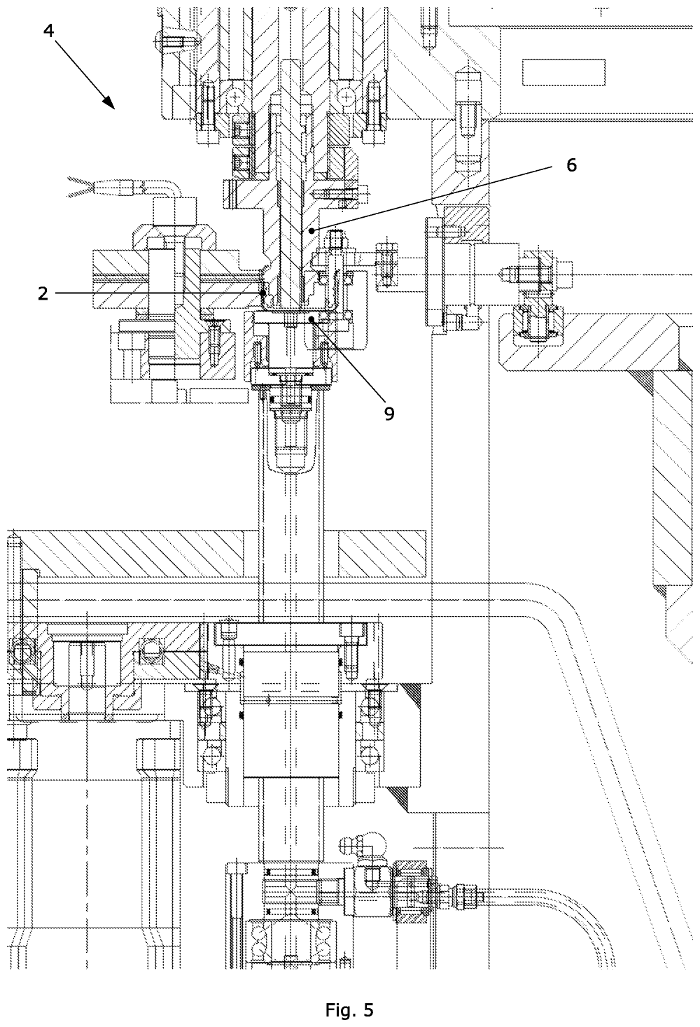

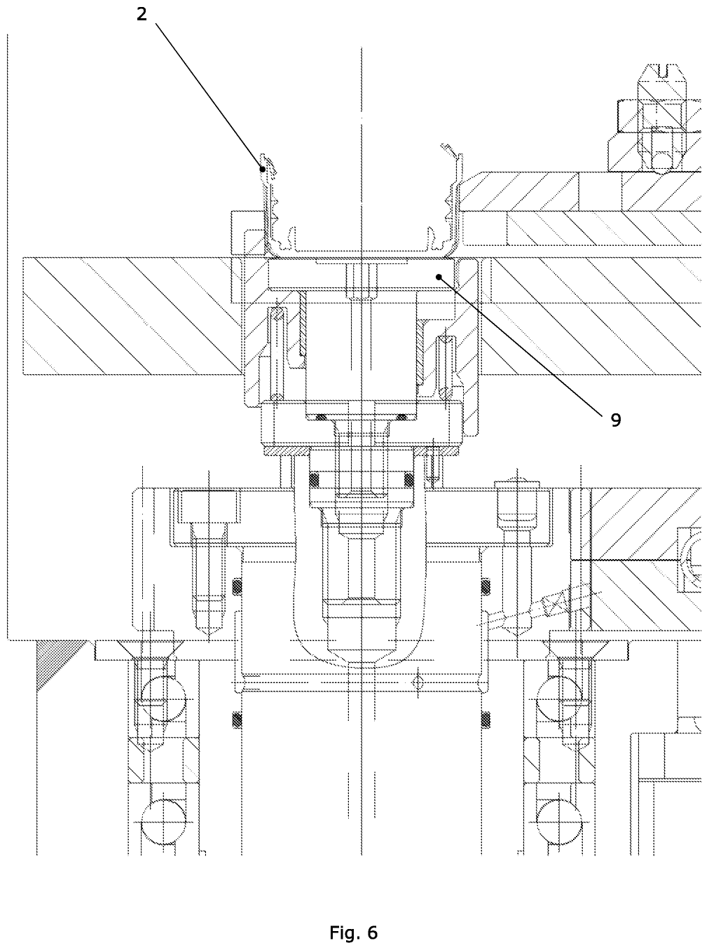

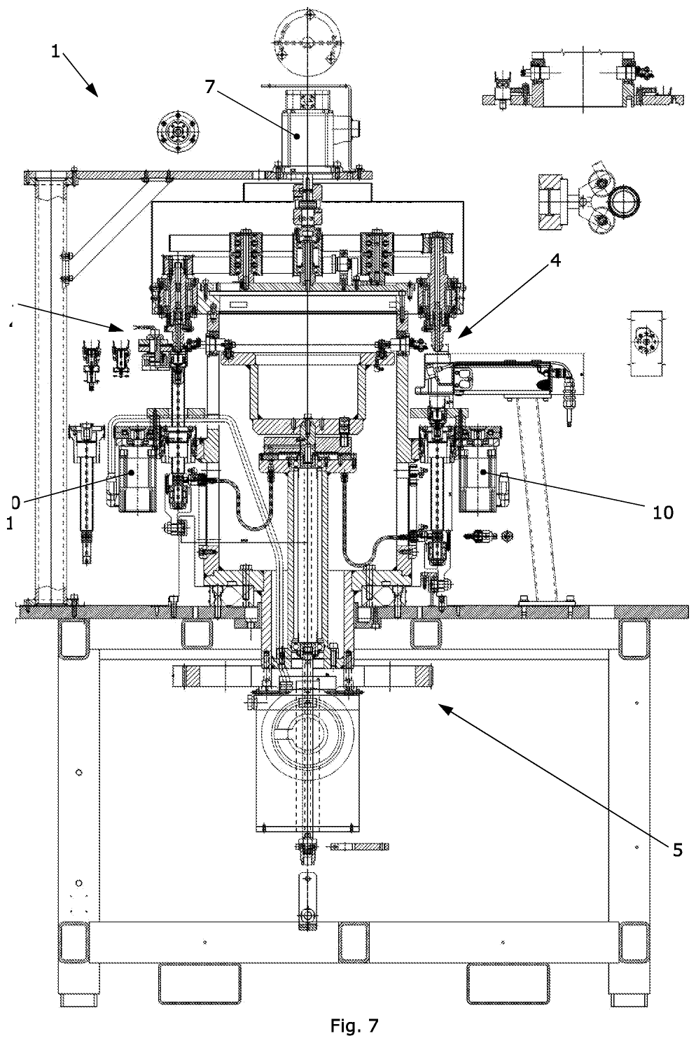

The support 9 can be made in different ways. In particular, the support 9 can include a single lower plate (in particular as in FIG. 2, a plate without a peripheral edge protruding upwards and capable of interacting with the capsule) that interacts supportingly in contact (with retaining by suction), with the flat end portion of the capsule (capsule arranged below in these embodiments) without substantially interacting with the skirt side portion. The support 9 can include, in particular (for example as in FIG. 6), a beaker-shaped plate to contain laterally, at least partly, the capsule, with the possibility of interacting with the skirt side portion. The support 9 can include, in particular, an elastic element (for example like those visible in FIGS. 6, 13 and 14) to permit a sprung movement of the support 9. The beaker shape and/or the possibility of a sprung movement can promote retaining of the capsule, especially when the support 9 is rotated by a motor unit.

The support 9 can be provided with an engagement member (for example knurling) configured to engage a counter-engaging member (for example fixed counter-knurling) arranged in the cutting zone to promote rolling movement (without sliding) of the capsule on the cutting arrangement.

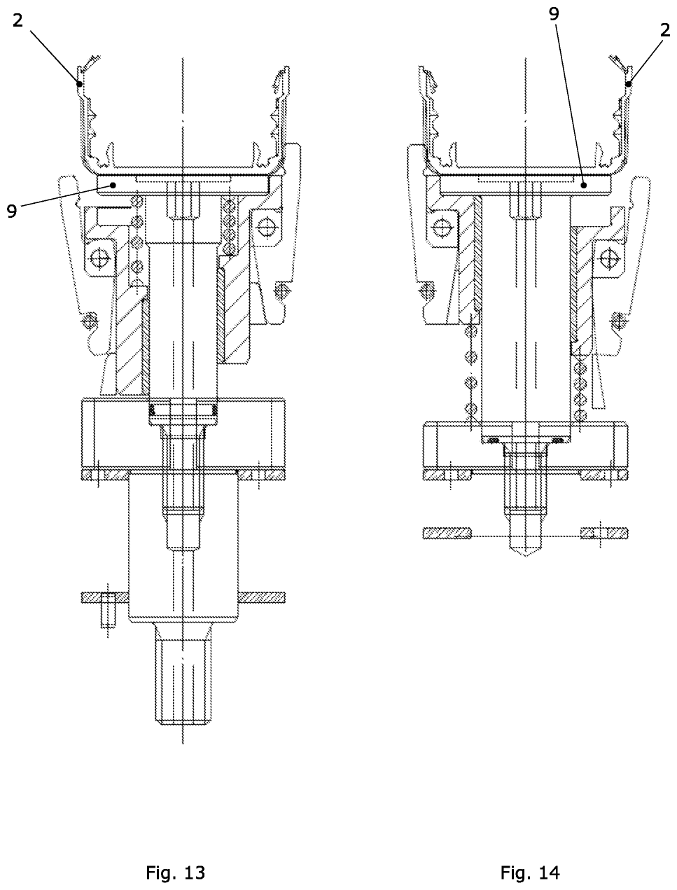

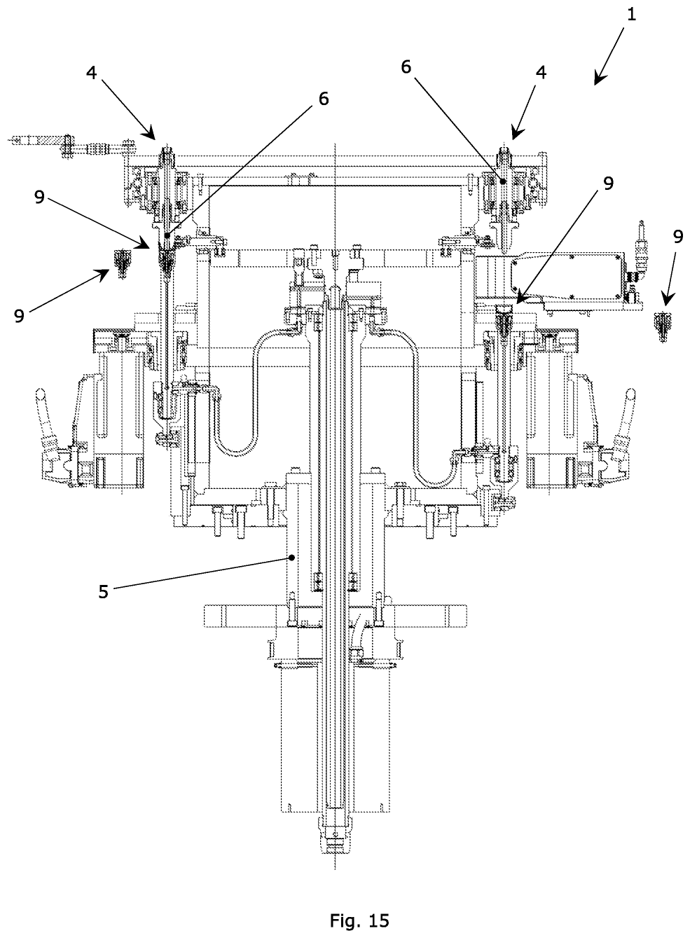

The support 9 can include, in particular (for example as in FIGS. 13 and 14), a lateral capsule containing arrangement provided with movable portions (for example with hinge movement) with the possibility of adopting a closed configuration, in which they contain laterally the side portion of the capsule, and an open configuration in which they leave the capsule free.

As said, the support 9 can include, in particular, an elastic element configured for sprung movement of the support. This elastic element can be arranged, in particular, between the capsule support plate and a tubular element that can be movable axially and can carry the lateral containing arrangement (as in FIG. 13). It is possible to provide, for example as in FIG. 14, for the elastic element being arranged, in particular, in such a manner that the tubular element is interposed between the capsule support plate and the elastic element.

In operation, a cutting method is implemented that can include, in particular, the step of supplying the capsules 2 to the cutting arrangement 3 to make a guarantee band or tamper ring on each capsule 2, the step of detecting an orientation (or angular arrangement) of each capsule 2, and the step of varying an orientation of each capsule 2 based on the aforesaid detection. The aforesaid step of varying the orientation of the capsule 2 is performed before the capsule reaches the cutting arrangement 3, so that each capsule 2 reaches the cutting arrangement 3 with a desired orientation, or angular position, with respect to the cutting arrangement 3. The cutting apparatus 1 can be designed, in particular, to perform one or more cuts on the (side) wall of the capsule 2, in particular, as said, in order to make a tamper ring intended to break the first opening of the capsule.

In operation, initially each capsule 2 to be cut reaches the respective feeding unit 4 with a random orientation with respect to the support rotation axis. The sensor unit 13 is arranged to determine the actual orientation (or “phase”) of each capsule 2, in particular the angular position of the capsule 2 with respect to the support rotation axis, along the capsule path before the cutting arrangement. As said, the carousel 5 supports the plurality of feeding units 4, that are spaced angularly apart from one another. The various feeding units 4 are accordingly movable around the carousel rotation axis along a circumferential path.

Each feeding unit 4 is, as said, provided with a (lower) support 9 that can include, in particular, a plate for retaining, for example by a vacuum, a capsule 2 positioned thereupon. Depending on the orientation of the capsule 2, which is detected by the sensor unit 13, the electronic control device of the cutting apparatus 1 is configured to rotate the support 9, around the support rotation axis, by the motor of the respective feeding unit 4, in order to position the capsule in a desired phase (corresponding angular position) with respect to the cutting unit 3 before performing the subsequent cut.

Further, the support 9 is also guided in translation to approach the respective spindle 6 (i.e. upwards), in a (vertical) direction parallel to the support rotation axis, by the profile of the shape 11 of the cam arrangement. Feeding the capsules 2 thus includes a movement that includes adjustment of the angular position, a sort of “angular phasing”, by rotation of the lower support 9 that carries the capsule 2, combined with upward translation of the lower support 9. The rotation adjustment occurs by driving the actuator device 10 (for example one electric motor for each feeding unit 4), and approaching in translation the profile of the shape 11. The shape 11 is shaped and arranged so as to guide a return of the support 9 to the lowered position (i.e. with a descent movement) to pick up another capsule 2.

The upper spindle 6, which can be fixed in a vertical direction, is rotatable around the spindle rotation axis by the motor unit 7 and the motion transmitting arrangement 8 that connects the spindle 6 to the aforesaid motor unit 7.

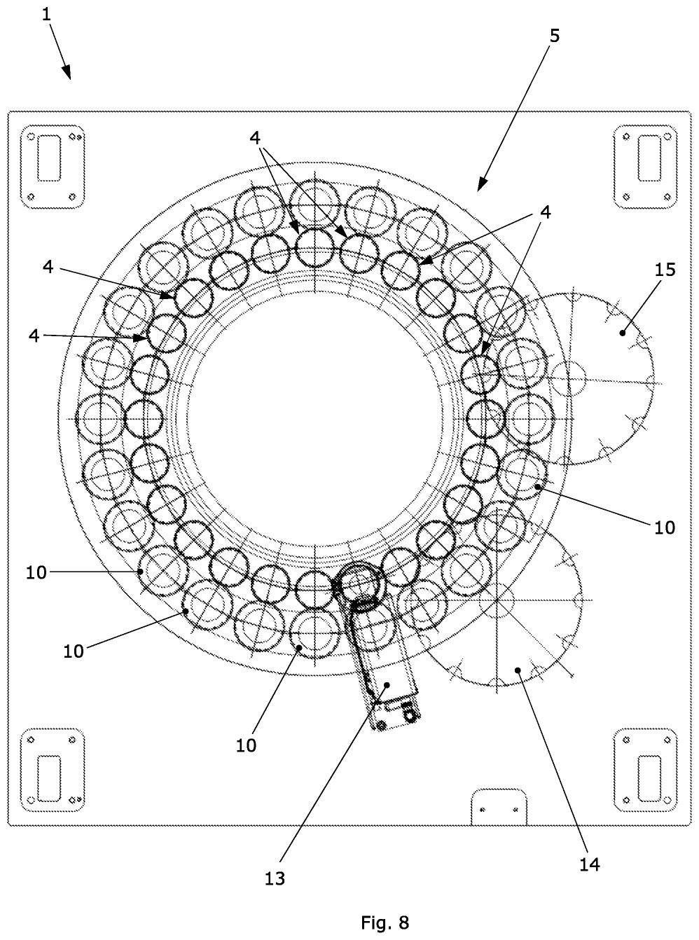

The feeding device can include, in particular, an inlet device 14 (for example an inlet carousel, see FIG. 8) to insert the capsules 2 into the cutting carousel 5 (rotating in a clockwise direction in FIG. 8) upstream of the sensor unit 13. The feeding device can include, in particular, an outlet device 15 (for example an outlet carousel, see FIG. 8) to extract the capsules 2 from the cutting carousel 5 downstream of the cutting arrangement 3 (not illustrated in FIG. 8) arranged along the path of the capsules between the sensor unit 13 and the outlet device 15.

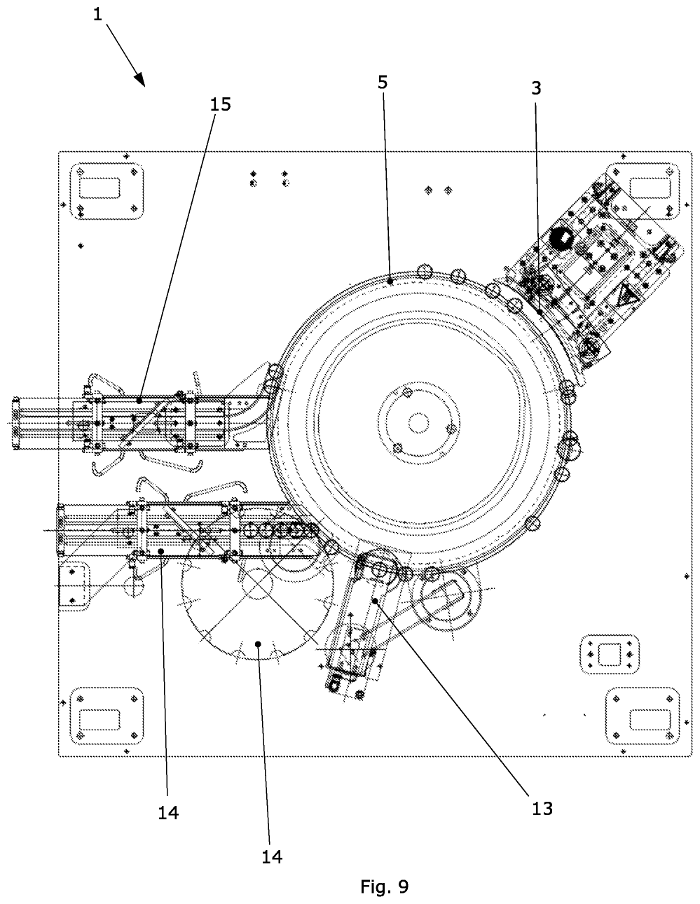

The inlet device 14 can include, in particular, a linear conveyor (see FIG. 9), alternatively or in addition to the inlet carousel, to insert the capsules into the cutting carousel 5 (rotating in an anticlockwise direction in FIG. 9) upstream of the sensor unit 13. The outlet device 15 can include, in particular, a linear conveyor (see FIG. 9), alternatively or in addition to the outlet carousel, to extract the capsules 2 from the cutting carousel 5 downstream of the cutting arrangement 3 arranged along the path of the capsules 2 between the sensor unit 13 and the outlet device 15.

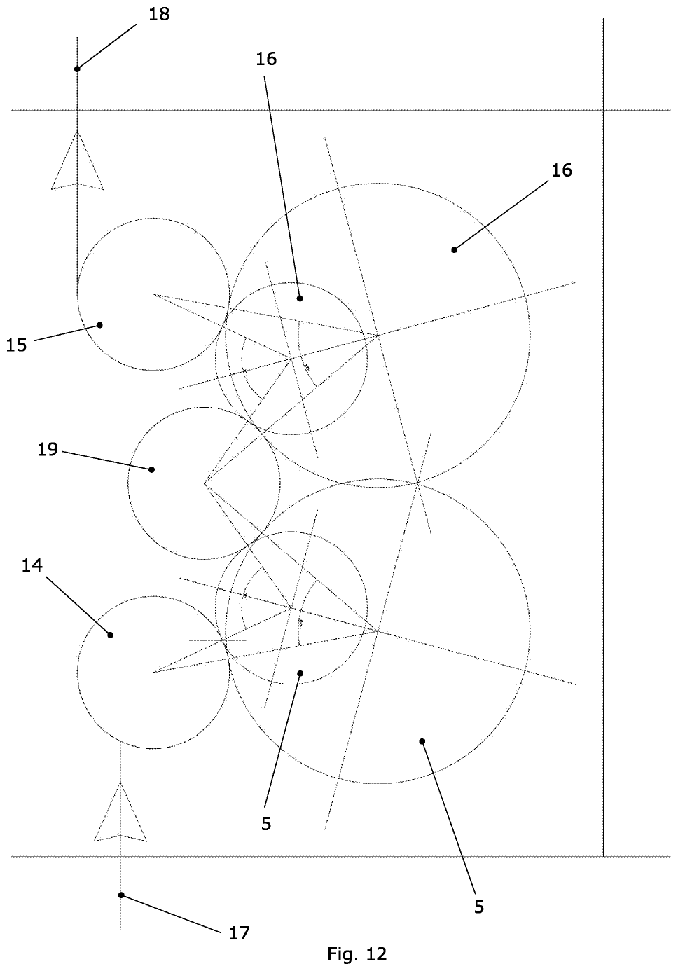

The cutting apparatus 1 can be, in particular, connected in a continuous line with a folding apparatus 16 (for example of the carousel type, as in FIG. 12) arranged to receive the capsules 2 coming from the cutting apparatus 1 and to perform folding of the guarantee band for each capsule 2. FIG. 12 shows a plant for processing capsules with a capsules inlet 17, a capsules outlet 18 and a schematic overlay of a plurality of capsule conveying carousels arranged between the capsules inlet 17 and the capsules outlet 18. The plurality of conveying carousels can include, in particular, the inlet device 14, the cutting carousel 5, an intermediate carousel 19, the folding apparatus 16 and the outlet device 15.

The inlet device 14 yields the capsules 2 to the cutting carousel 5. The cutting carousel 5 can include, alternatively, a large carousel or a small carousel. The cutting carousel 5 leaves the capsules 2 to the intermediate carousel 19. The intermediate carousel 19 leaves the capsules 2 to the folding apparatus 16. The folding apparatus 16 can include, alternatively, a large carousel or a small carousel. The folding apparatus 16 leaves the capsules 2 to the outlet device 15.

It is possible to provide various combinations: large cutting carousel 5 and large folding apparatus 16, large cutting carousel 5 and small folding apparatus 16, small cutting carousel 5 and large folding apparatus 16, small cutting carousel 5 and small folding apparatus 16. In specific embodiments, the cutting carousel 5 is large and the folding apparatus 16 can be large or small. In specific embodiments, the cutting carousel 5 can be arranged before the folding apparatus 16, or can be arranged after the folding apparatus 16, with reference to the advancement direction of the capsules being processed.

In one cutting step, the capsule 2 is carried (in phase, i.e. with a desired orientation or angular position) by the lower support 9 abutting on the upper spindle 6. Subsequently, when the capsule 2 reaches the cutting arrangement 3, it is possible for the spindle 6 to rotate together with the capsule 2, which rolls without sliding on the cutting arrangement 3. During the cutting step, it is possible for the motor of the lower support 9 to be off (it had been switched on previously only to enable the lower support 9 to perform the aforesaid phasing of the capsule 2) and for the capsule 2, with the bottom surface, not to be able to slide with respect to the plate of the support 9 (if the motor of the lower support 9 is left off in neutral) or can slide with respect to the plate of the support 9 (if the motor is not neutral).

The carousel 5 rotates the plurality of feeding units 4, for each of which an (optical) detection of the corresponding capsule 2 is made that is positioned on the support 9 (in particular on the support plate). The detection involves in particular the detection of elements or geometric features of the capsule 2 that are suitable for determining an angular position of the capsule with respect to a vertical axis.

The rotation of the capsule 2, i.e. the adjusting movement for adjusting the angular position of the capsule, is performed by the actuator device 10, i.e. the motor associated with each respective feeding unit 4, which actuator device 10 is kinematically connected to the support 9 (capsule support plate, with the capsule 2 rotating integrally with the plate). The adjusting rotation will be the same as the angle such as to carry the capsule 2 in an angular reference position, i.e. a desired angular position that will enable the capsule 2 to meet the (fixed) cutting arrangement 3 at a precise point of the capsule. Accordingly, the capsule 2 can be fed appropriately to the cutting arrangement 3, on which it can roll without sliding. The action of cutting the cutting arrangement 3 on the capsule will start in the desired point of the capsule 3, by virtue of the adjusting of the angular position performed previously. The cutting step can be performed with the upper spindle 6 that is rotated and rotates the capsule 2, thus accompanying the rolling movement of the capsule 2 on the cutting arrangement 3 (knife/knives), whereas the lower support 9 remains stationary (with the capsule 2 that slides on the plate), or is disconnected from the motor drive so as to rotate in neutral.

Alternatively, the cutting step can be performed with the lower support 9 that is rotated and rotates the capsule 2, thus accompanying the rolling movement of the capsule 2 on the cutting arrangement 3 (knife/knives), whereas the upper spindle 6 can be devoid of motor drive so as to rotate in an idling manner, acting substantially only as an abutting element for the cutting arrangement 3.

It is noted that for both the solutions that have just been disclosed (active upper spindle or passive upper spindle) the spindle rotation axis can be coaxial with the geometric axis of the capsule 2, or can be eccentric (i.e. non coaxial) with respect to the geometric axis of the capsule 2.

The actuator device 10, which is configured to activate a rotation of the support 9 (plate or lower support base of the capsule 2), may be configured so that the support 9 rotates at the same angular speed with which the spindle rotates 6 at least at the exact moment, or just before the exact moment, in which the capsule 2, which is carried by the support 9, comes into contact with the spindle 6. In other words, the control device (electronic and programmable) may be configured, in particular, so that the rotation of the spindle 6 and the rotation of the support 9 are coordinated so that the relative rotation speed between the capsule 2 and the spindle 6 is zero when the capsule 2 and the spindle 6 come into mutual contact. In practice, in one example it occurs that, during the upward path or trajectory of the capsule 2 transported by the support 9, the support rotates 9 until it reaches, at the same moment, or at least a moment before, the mutual contact between capsule 2 and spindle 6, a desired rotation speed such as to cancel the relative rotation speed between capsule 2 and spindle 6. This allows, in particular, to avoid an undesired displacement of the capsule 2, for example with respect to the support 9, due to the interaction with the spindle 6.

In particular, it is possible to provide that the control device is configured in such a way as to perform a control mode which may include, for example, at least a first step of reading the position of the capsule. This first step may include, in particular, an acquisition of the angular position or orientation of the capsule by means of the sensor unit 13 and a processing of the signal coming from the sensor unit 13 to determine a desired rotation (in particular, the extent of the rotation with respect to the receiving position of the capsule 2 on the support 9) of the capsule 2 suitable for subsequently obtaining the desired orientation with respect to the cutting arrangement 3 at the moment of starting the interaction with the cutting arrangement 3.

The control mode may include, in particular, at least a second acceleration phase, in which, once the desired rotation of the support 9 has been determined, the support 9 begins to rotate (in a direction concordant with the rotation of the spindle 6) by increasing the rotation speed (in particular, with a relatively high acceleration and in any case compatible with the stability of the capsule 2 and the inertial conditions of the system) and the upward movement begins (i.e. approaching the spindle 6 positioned above). In this second acceleration phase, it is possible to provide, in particular, that an electronic data processing module sends to the control device a desired angular position that the capsule 2 must reach at a desired moment (for example the angular position that the capsule 2 must have with respect to the cutting arrangement 3 at the moment of beginning of the cutting phase or at the moment of execution of a vertical and/or oblique cut so that this vertical and/or oblique cut is made in a precise angular position on the capsule 2) in a manner that the control device is capable of controlling the actuator device 10 to adjust the rate of rotation of the support 9 in order to reach the desired angular position of the capsule 2 at the desired moment. This step of changing the speed of rotation of the support 9 may include, in particular, the step of correcting the trajectory of the capsule (performed in the path portion 12) with respect to a reference trajectory.

The control mode may include, in particular, at least a third phase of capsule release (subsequent to the second phase), which includes a meeting phase—in which the support 9 brings the capsule 2 to meet the spindle 6 in contact relationship, with the capsule 2 which, upon contact with the spindle 6, rotates at an angular speed equal to the angular speed of the spindle 6 (i.e. with a zero relative speed between capsule 2 and spindle 6) and is positioned with an appropriate orientation angular in order to reach the cutting arrangement 3 in the desired angular position—and a uncoupling step (subsequent to the meeting step)—in which the support 9 is mechanically uncoupled from the actuator device 10 so as to no longer receive the rotation motion by the actuator device 10 (in particular, by the electric motor), whereby the support 9 becomes rotatable in a substantially idle manner and the capsule 2 can be dragged by the spindle 6 alone which continues to be driven in rotation by the motor unit 7 (in practice it may be the spindle 6 that rotates the support 9 through the capsule 2). It has been seen that, in this way, i.e. by releasing the support 9 from the actuator device 10 before the capsule 2 reaches the cutting means 3, leaving only the spindle 6 to guide the rotation of the capsule 2, the cut performed by the cutting device 3 is particularly precise and reliable.

The cutting apparatus 1 may include, in particular, an uncoupling device for uncoupling (in particular, mechanically) at least a part of the support 9, that is a part carrying the capsule 2, from the actuator device 10. Such uncoupling device may be configured, in particular, to intervene in the aforementioned uncoupling step (when the capsule 2 has already been engaged by the spindle 6 and before the capsule 2 reaches the cutting arrangement 3). In the figure 24 indicates a first portion of the support 9 which is connected to the actuator device 10 and which is connected, by means of the uncoupling device, to a second portion 26 (for example with the capsule supporting plate) which carries the capsule 2 and which is connected to the first portion 24 when the capsule 2 is to be rotated by the actuator device 10.

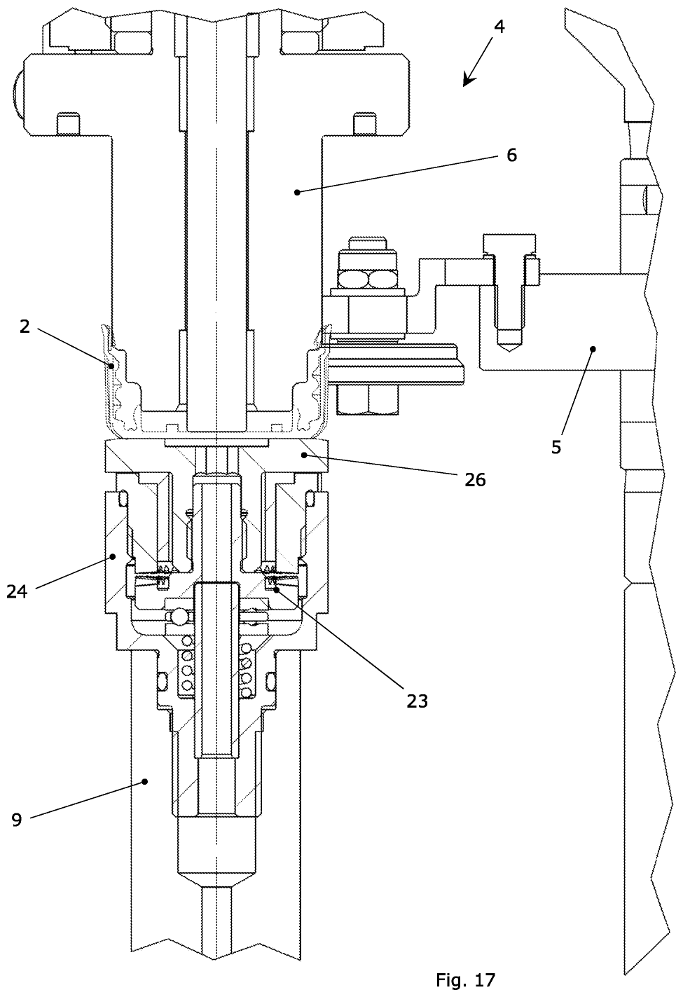

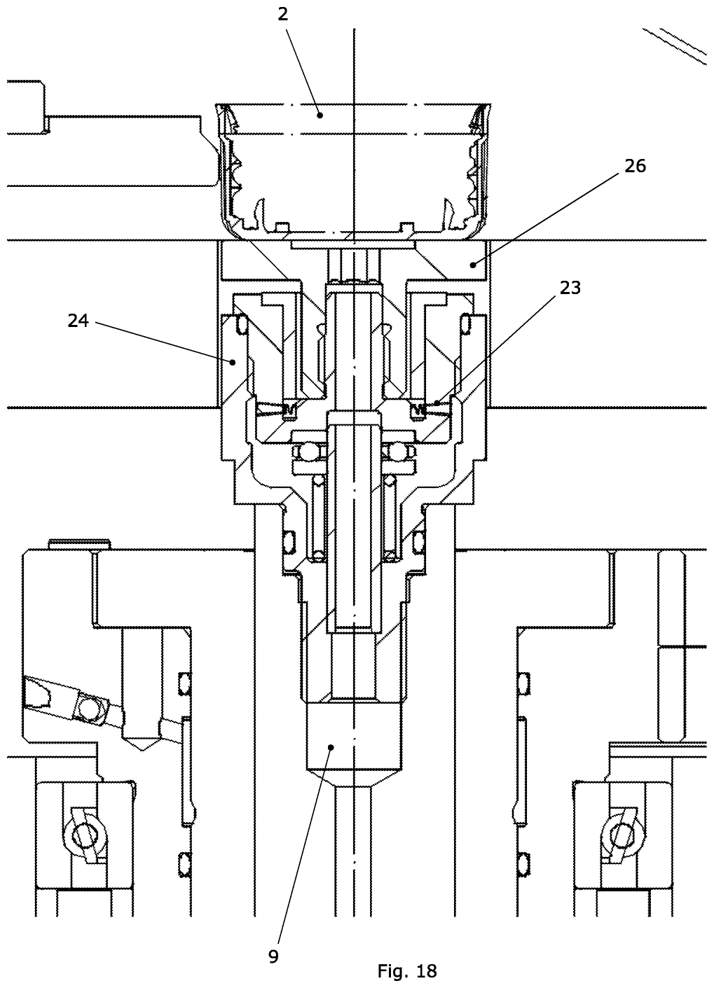

Said uncoupling device may include, in particular, a splined coupling 23 with an elastic element (for example, a spring) for disengaging and with a guide device which keeps the splined coupling 23 active when the support 9, in particular the part of the support 9 which carries the capsule 2, must be rotated by the actuator device 10 and leaves the splined coupling 23 free (which can be deactivated by the elastic element) when the part of the support 9 which carries the capsule 2 must be released from the actuator device 10 and rotated only by the spindle 6. FIG. 17 shows an example of splined coupling 23 in disengagement configuration (whereby the actuator device 10 does not transmit motion to the part of the support 9 which carries the capsule 2, at least in the period of time in which the capsule 2 interacts with the cutting arrangement 3) and in FIG. 18 the splined coupling 23 is shown in the engagement configuration (whereby the actuator device 10 transmits the motion to the portion of the support 9 which carries the capsule 2, at least in the period of time in which the capsule 2 is carried by the support 9 and transferred to the spindle 6 with zero relative rotation speed.

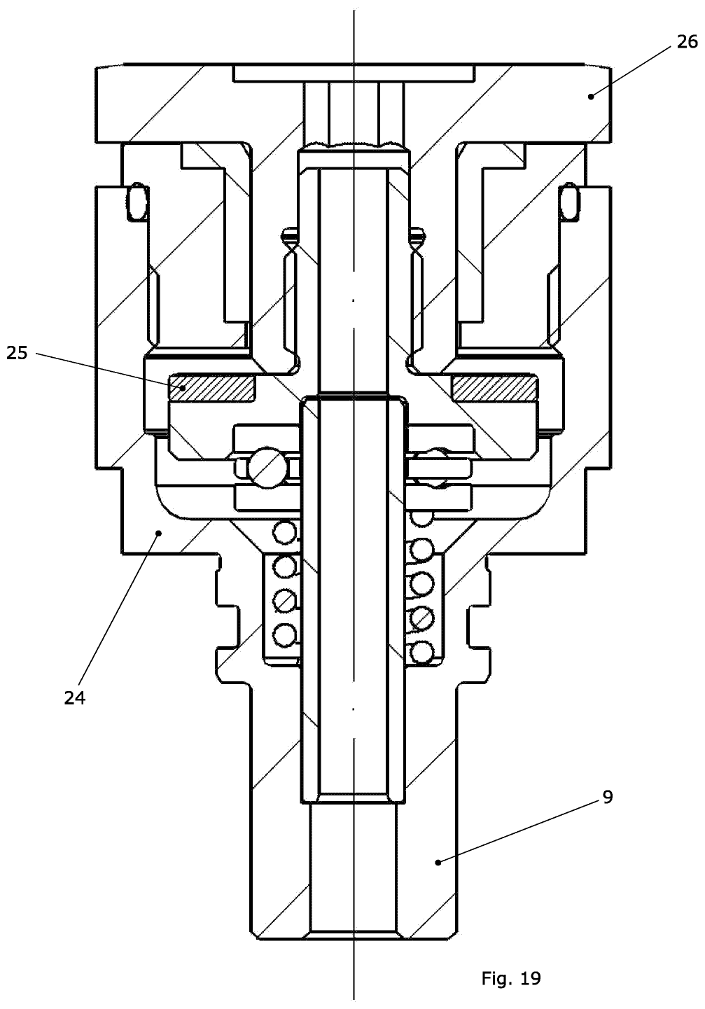

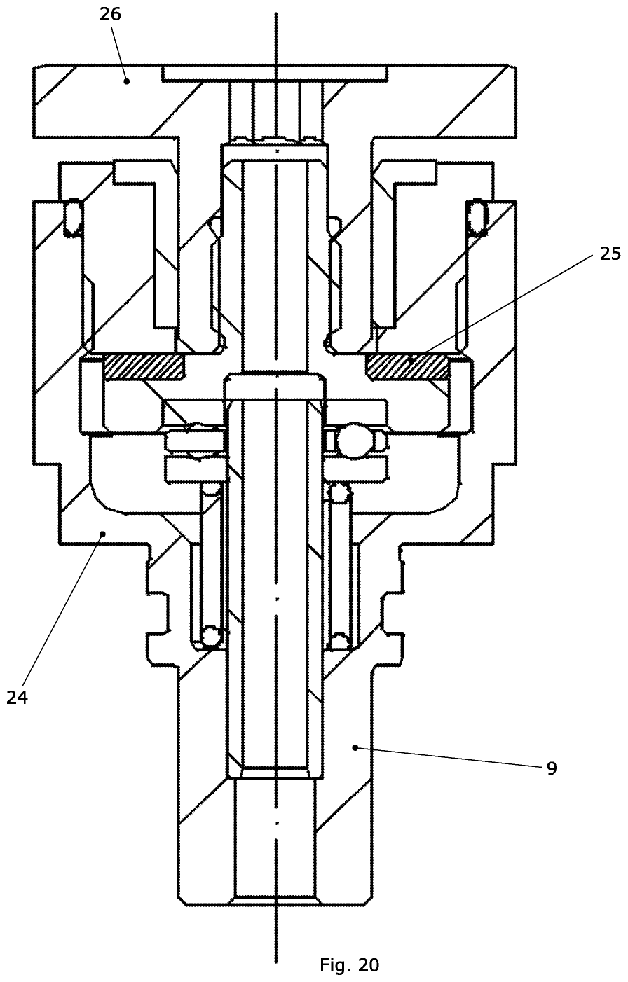

Said uncoupling device may include, in particular, a magnetic device which is arranged between the actuator device 10 and the part of the support 9 which carries the capsule 2 and which is capable of assuming an operative connection configuration (FIG. 20), in which the first portion 24 (connected to the actuator device 10) is connected, for example by means of one or more magnets 25, to the second portion 26 which carries the capsule 2 and which, in this operative connection configuration, is connected to the actuator device 10 and which, therefore, can rotate the capsule 2, and an operational disconnection configuration (FIG. 19), in which the first portion 24 is disconnected, for example being guided by a fixed guide system (of the cam type), to the second portion 26 when the second portion 26 must be released from the actuator device 10 which no longer rotate the capsule 2.

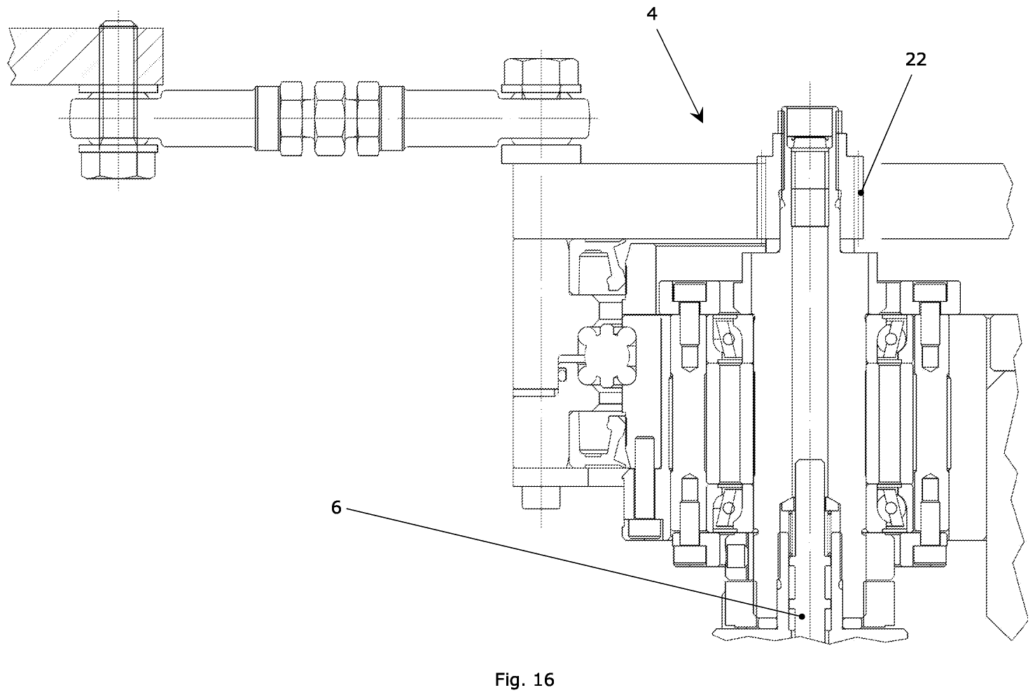

In an embodiment (for example as shown in FIG. 16) the motion transmitting arrangement 8 may include a transmission arrangement 22 of the gear type, in particular with two or more toothed wheels configured to transmit the rotational motion of the axis of the carousel 5 to the axis of rotation of the various spindles 6 carried by the carousel 5. The gear-type transmission arrangement 22 for transmitting motion to the spindles 6, in combination with the uncoupling device for uncoupling the support 9 from the actuator device 10, allows to achieve some advantages, such as, for example, a considerable reduction, or substantially elimination, of the play in the coupling between the various mechanical members, and/or a high precision in the movement of the capsules 2 with a consequent high precision of cut. In addition, it was found that the high degree of precision is presented with high repeatability in a uniform manner between one cutting apparatus and another. It is possible to control the reciprocal position (or phasing) between movable tools (in particular the various spindles 6) and fixed tools (in particular the cutting arrangement 3) in a precise and reliable way at any operating speed of the cutting apparatus.

In one example, the operation of the cutting apparatus may include a logic defined by the following operating phases.

An operating phase may include, in particular, the activation of the actuator device 10 (by means of the electronic and programmable control device) to rotate the support 9 so as to carry out both the phasing of the capsule 2 (i.e. the achievement of the desired angular orientation of the capsule 2 with respect to the cutting arrangement 3 in order to perform a cut in a determined position of the capsule 2), and the achievement of the desired rotation speed of the capsule 2 (equal to the rotation speed of the spindle 6) at the moment in which the capsule 2, in its upward trajectory towards the spindle 6, comes into contact with the spindle itself.

The actuator device 10 may include, in particular, an electric motor, for example a brushless motor (even if it is possible to use a motor of another type, such as, for example, a stepping motor, a brush motor, a synchronous motor with inverter, etc.). This electric motor may be managed, in particular, by means of an electronic cam. In particular, the electronic cam may be configured in such a way as to control the motion (in particular, the angular speed and/or the angular acceleration) of the support 9 during the entire path followed by the support 9 at least from the moment of reception of the signal coming from the inspection system (with sensor unit 13) up to at least the moment of transfer of the capsule 2 to the spindle 6. The signal coming from the inspection system (i.e. the angular position of the capsule 2 detected by the sensor unit 13 and processed by the electronic module processing) may be, in particular, indicative of a certain correction angle which corresponds to the rotation suitable for varying the orientation of the capsule 2 with respect to a reference orientation. This correction angle is used in combination with a basic control set for each support 9, where the basic control set essentially corresponds to the rotation control of the support 9 suitable for bringing the capsule 2 into contact with the spindle 6 with zero relative rotation speed, in the event of a correction angle equal to zero, that is, when the capsule 2 has an orientation equal to the reference orientation. Correction from the basic set will generally result in a reduction or increase in the path followed by the support 9 from the default path following the basic set. The correction may be performed and completed by the support 9 before the transfer of the capsule 2 to the spindle 6, so that when the capsule carried by the support 9 is engaged by the spindle 6 and then driven into rotation by the spindle 6 alone (since the actuator device 10 is released from the support 9), the capsule 2 is already in the suitable angular position or orientation (phasing) in relation to the subsequent execution of the cut by the cutting arrangement 3.

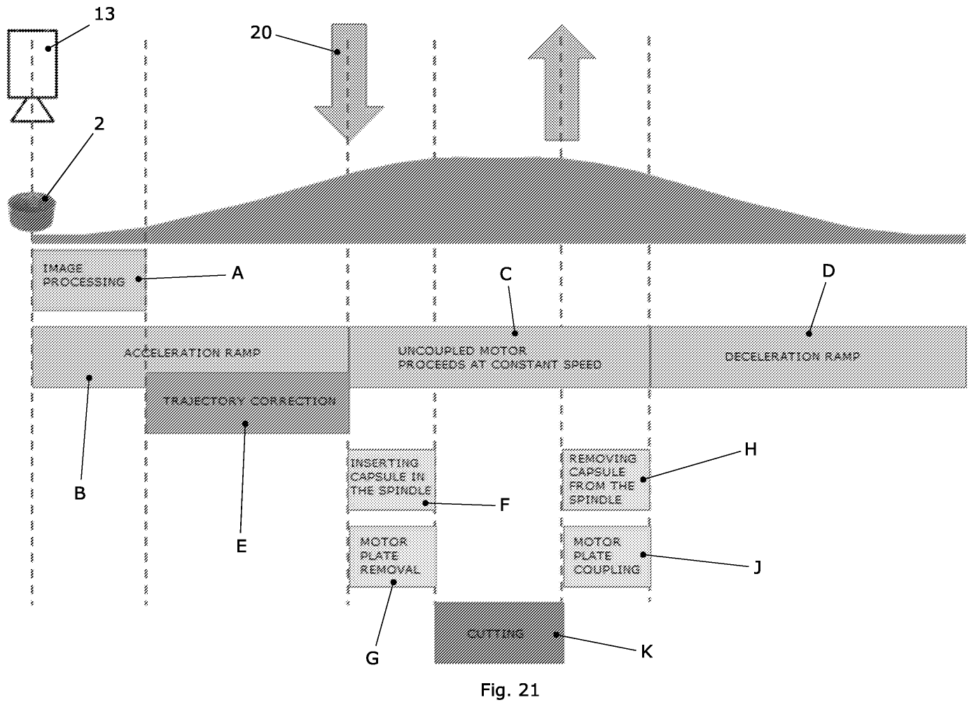

FIG. 21 shows an example of operation of the apparatus in question, by means of a two-dimensional graph which represents, on the abscissa, a complete revolution of the carousel 5 (starting from the position of the sensor unit 13) and, on the ordinate, the rotation speed of a rotor of the actuator device 10 (brushless motor), and where the time intervals of execution of the various sequential operating phases are shown below the curve of the rotation speed of the actuator device 10. In particular, FIG. 21 shows the time interval A for processing the image detected by the sensor unit 13, the time interval B of the acceleration ramp of the support 9 (mechanically connected to the rotor of the actuator device 10), the time interval C in which the actuator device 10 is released from the support 9, since the rotor of the actuator device 10 is released from the support 9 (and in which the rotor may be driven, in particular, at a constant rotation speed), the time interval D of the deceleration ramp of the support 9 (again mechanically connected to the rotor of the actuator device 10), the time interval E during which the correction of the angular position of the support 9 takes place (in which the actuator device 10 rotates the support 9 of the correction angle calculated with respect to the reference control), the time interval F of capsule insertion during which the transfer of the movement of the capsule 2 takes place which passes a from the support 9 to the spindle 6, the time interval G of decoupling where the decoupling between the support 9 and the rotor of the actuator device 10 takes place (to achieve the substantial transfer of the capsule from the support 9 to the spindle 6), the time interval H of capsule extraction where, in particular, the extraction of the capsule 2 from the spindle 6 can take place (the capsule 2 may, for example, continue its path towards subsequent processing), the time interval J of coupling during which the support 9 goes back to being coupled with the rotor of the actuator device 10, the time interval K of cutting during which the cutting of the capsule 2 by the cutting arrangement 3 takes place. It should be noted that the time interval K is subsequent to the time interval F and/or the time interval G. Note that the time interval K is prior to the time interval H and/or the time temporal J.

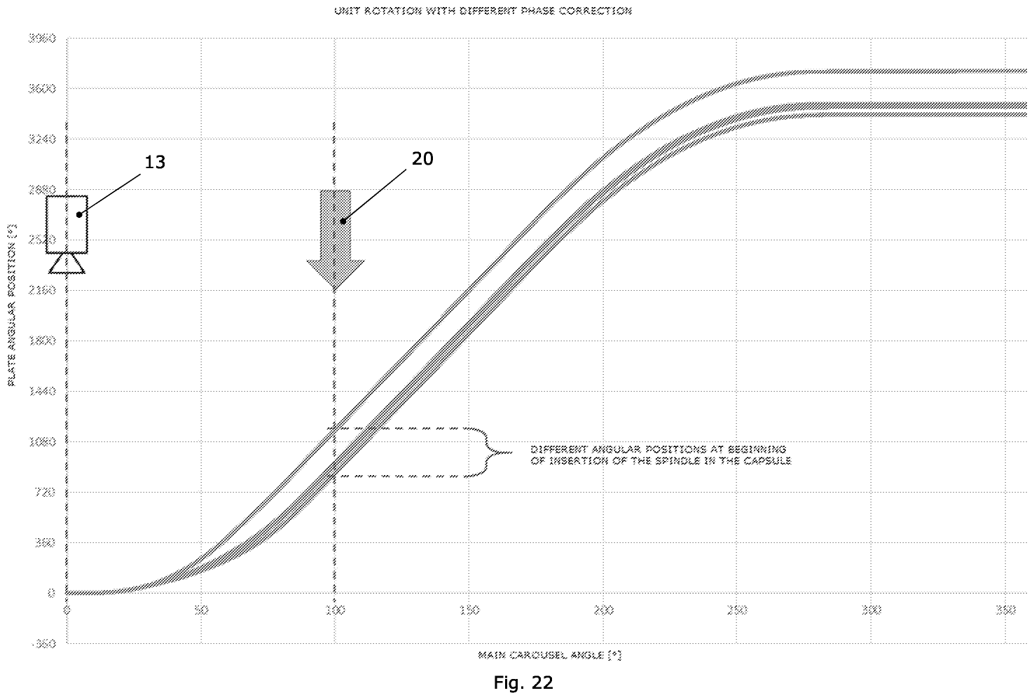

FIG. 22 shows an example of operation of the apparatus in question, by means of a two-dimensional graph which represents, on the abscissa, the angular position of the carousel 5 during a complete revolution (starting from the position of the sensor means 13) and, on the ordinate, the angular position of the support 9, with three curves representing the angular position of the support 9 in case of three different correction angles (corresponding to three different orientations or initial angular positions of the capsule 2 starting from the detection of the sensor unit 13, where these orientations or angular positions are substantially random), in which the three different angular positions assumed by the support 9 at start moment of the spindle 6 insertion into the capsule 2 are highlighted (in the specific example this moment occurs at the angle 1000 of rotation of the carousel 5, as indicated by the arrow 20 also present in FIG. 21), due to the different angle of correction controlled by the actuator device 10. In substance, in this specific example the correction of the orientation is performed exclusively by the actuator device 10 when it is still connected to the support 9, so that when the capsule 2 is transferred to the spindle 6 it is in the correct angular position and therefore the motor unit 7 may not contribute to the correction of the angular position of the capsule 2. It is however possible to provide other examples in which the motor unit 7 can collaborate with the actuator device 10 to carry out the correction, or in which such correction of the orientation of the capsule 2 (the “phasing”) is performed only by the motor unit 7.

As said, FIG. 16 shows, in particular, the motion transmitting arrangement 8 in the example of the gear type transmission arrangement 22, configured to control the movement of the spindle 6 so that the spindle 6 is put “in phase” with the cutting arrangement 3, i.e. so that the cuts on the capsule 2 are made in desired angular positions of the capsule 2, in particular in order to make at least one vertical and/or oblique cut in a desired angular position on the capsule 2.

FIGS. 19 and 20 show an example of uncoupling device, arranged to uncouple the support 9 from the actuator device 10 (so as to make the support 9 rotate in a substantially idle way, as it is no longer mechanically connected to the actuator device 10, so that it may be the capsule 2 that guides the rotation of the support 9 and not vice versa), with a coupling and release device by means of the splined coupling 23. FIGS. 20 and 21 show an example of uncoupling device, arranged to uncouple the support 9 from the actuator device 10, by means of a coupling and release device including one or more magnets 25.

1. Cutting apparatus, including:
a feeding device for feeding capsules;
a cutting arrangement for making a guarantee band on each capsules fed by said feeding device;
a sensor unit for detecting an orientation of each capsule;
an actuator device for varying an orientation of each capsule, and
a control device configured to control said actuator device based on a detection of said sensor
unit;
wherein said control device is configured so as to vary the orientation of each capsule before the capsules reaches said cutting arrangement so that the capsules reach said cutting arrangement with a desired orientation with respect to said cutting means arrangement.

2. Apparatus according to claim 1, wherein said feeding device includes at least one feeding unit movable along a path where said cutting arrangement is arranged, said at least one feeding unit being configured to feed at least one capsules and including a spindle rotatable around a spindle rotation axis, said spindle being configured to engage with the capsules while the capsules rolls on said cutting arrangement; said spindle being configured; to engage with an internal surface of the capsules facing upwards.

3. Apparatus according to claim 2, comprising a motor unit configured to rotate said spindle rotation axis when said spindle is engaged with the capsules while the capsules roll on said cutting arrangement; and wherein said feeding device includes a carousel rotatable around a carousel rotation axis and arranged to support said at least one feeding unit, said apparatus including a motion transmitting arrangement configured so that a rotation of a rotation axis of said motor unit causes a rotation of said spindle rotation axis; said apparatus being configured so that said carousel rotation axis is coaxial or coincident with said rotation axis of said motor unit; and wherein said motion transmitting arrangement includes one or more flexible members and one or more gears arranged to connect together said axis of rotation of said motor unit and said spindle rotation axis.

4. (canceled)

5. (canceled)

6. Apparatus according to claim 1, wherein said feeding device includes at least one feeding unit configured to feed at least one capsules, said at least one feeding unit including a support rotatable about a support rotation axis, said support being configured to engage the capsules and to receive a rotational motion from said actuator device to vary an orientation of the capsules with respect to said support rotation axis before the capsules reaches said cutting arrangement so that the capsules meets said cutting arrangement with a desired orientation with respect to said cutting arrangement; and wherein said support is configured to engage the capsules with a suction holding member; said support being configured to engage an outer surface of the capsules facing downwards; and wherein said at least one feeding unit includes a spindle rotatable about a spindle rotation axis, said support being capable of performing an axial motion in both directions with respect to said spindle so as to approach and move away from said spindle; said axial motion of said support being guided by a cam arrangement; said cam arrangement including, in particular, a fixed cam profile and a tappet coupled with said support.

7. (canceled)

8. (canceled)

9. Apparatus according to claim 1, wherein said feeding device includes two or more feeding units each of which is configured to feed at least one capsules, said two or more feeding units being movable along a closed loop path and being arranged on a rotatable carousel.

10. Apparatus according to claim 1, wherein said feeding device includes a carousel rotatable around a carousel rotation axis, said carousel being arranged to support two or more feeding units each of which is configured to feed at least one capsules to said cutting arrangement, each of said two or more feeding units including a spindle rotatable around a spindle rotation axis, said spindle being configured to engage with the capsules while the capsules roll on said cutting arrangement, said spindle being configured to engage with an internal surface of the capsules facing upwards, said actuator device including, for each of said two or more feeding units, at least one motor carried by said carousel, each of said two or more feeding units including a support rotatable around a support rotation axis, said support being configured to engage the capsules and to receive a rotational motion from the respective said motor to vary an orientation of the capsules with respect to said support rotation axis before the capsules reaches said cutting arrangement so that the capsules meets said cutting device with a desired orientation with respect to said cutting arrangement, said support being configured to engage an external surface of the capsules facing downwards.

11. Apparatus according to claim 10, including a motion transmitting arrangement configured so that, while the capsules roll on said cutting arrangement, a rotation of an axis of rotation of motor unit causes a rotation of said spindle rotation axis, said support being configured so that, while the capsules rolls on said cutting arrangement, said support rotation axis is fixed or rotatable in an idle manner and wherein each of said two or more feeding units is configured so that, while the capsules rolls on said cutting device, the respective said motor drives said support rotation support axis while said spindle rotation axis is rotatable in an idle manner.

12. (canceled)

13. Apparatus according to claim 1, wherein said sensor unit includes an optical unit, for example a camera, and wherein said actuator device includes at least one motor driven along a path by said feeding device together with the capsules, and wherein said control device includes a programmable electronic device and computer instructions implemented on said programmable electronic device.

14. Cutting method implemented by a cutting apparatus according to claim 1, said method including the steps of:
feeding capsules to a cutting arrangement to make a guarantee band on each capsule;
detecting an orientation of each capsule; and
varying an orientation of each capsule on the basis of said detection; wherein said varying is performed before the capsules reaches said cutting arrangement so that the capsules reach said cutting arrangement with a desired orientation with respect to said cutting arrangement.

15. Cutting method according to claim 14, said cutting method including the following steps:
placing a capsule on a support;
rotating said support around a support rotation axis by an actuator device to rotate said capsule on itself;
rotating a spindle around a spindle rotation axis by a motor unit distinct from said actuator device;
bringing said support and said spindle closer together so that said capsule engages between said support and said spindle;
actuating said actuator device and said motor unit so that, when said capsule begins to engage between said support and said spindle, said capsule has a rotation speed around said support rotation axis equal to the rotation speed of said spindle around said spindle rotation axis;
bringing said capsule into rolling contact with a cutting arrangement to form a guarantee band on said capsule.

16. Method according to claim 15, including the step of uncoupling at least a part of said support from said actuator device.

17. Method according to claim 16, wherein said step of uncoupling said support from said actuator device occurs after said capsule is engaged between said support and said spindle and wherein said step of uncoupling said support from said actuator device occurs before said capsule comes into rolling contact with said cutting arrangement.

18. (canceled)

19. Method according to claim 10, including an initial step of reading an angular position of said capsule by a sensor unit and a subsequent step of processing a signal coming from said sensor unit for determining a desired rotation of the capsule suitable for obtaining a desired orientation with respect to said cutting arrangement at the moment of starting a cutting operation.

20. Method according to claim 10, including a step of mutual approaching between said support and said spindle, wherein, during said step of mutual approaching, said capsule is carried by said support which corrects an angular orientation of said capsule with respect to a reference orientation to obtain a desired orientation with respect to said cutting arrangement; and wherein said correction is terminated when said capsule comes into contact with said spindle, whereby the latter transports said capsule to said cutting arrangement without performing further orientation correction actions.

21. (canceled)

22. Method according to claim 10, wherein said actuator device repeatedly performs an operating cycle which includes, after a preliminary step of reading an angular position of a capsule by a sensor unit, at least an initial step of angular acceleration of said support during which said actuator device transmits a rotational motion to said support to bring said support to rotate with the same angular speed of said spindle, at least an intermediate step at constant angular speed during which said actuator device is released from said support so that said actuator device no longer transmits a rotational motion to said support and said capsule is rotated by said spindle, and at least a final deceleration phase and including a step of correcting an angular orientation of said capsule with respect to a reference orientation to obtain a desired orientation with respect to said cutting arrangement, said correction step being performed during said acceleration phase.

23. (canceled)

24. Cutting apparatus for carrying out a method according to claim 14, said apparatus including a feeding device for feeding capsules and a cutting arrangement for making a guarantee band on each capsule fed by said feeding device, wherein said feeding device includes at least one feeding unit movable along a path where said cutting arrangement is arranged, said at least one feeding unit being configured to feed at least one capsule and including a support rotatable around a support rotation axis and a spindle rotatable around a spindle rotation axis, said support and said spindle being configured so that the capsule is first engaged by said support and is subsequently engaged between said support and said spindle which is configured to engage the capsule while the capsule rotates on said cutting arrangement, wherein said apparatus includes an actuator device for rotating said support around said support rotation axis, a motor unit distinct from said actuator device for rotating said spindle around said spindle rotation axis, and a control device configured to actuate said actuator device and said motor unit so that, when the capsule engages between said support and said spindle, the rotation speed of said support around said support rotation axis is equal to the rotation speed of said spindle around said spindle rotation axis.

25. Apparatus according to claim 24, including an uncoupling device configured to uncouple a first portion of said support from a second portion of said support, said second portion carrying the capsule and said first portion being connected to said actuator device, to interrupt the transmission of motion from said actuator device to said second portion after the capsule is engaged between said support and said spindle and before the capsule comes into rolling contact with said cutting means; and wherein said uncoupling device includes at least one splined coupling; and wherein said uncoupling device includes at least one device with magnets.

26. (canceled)

27. (canceled)

28. Apparatus according to claim 24, wherein said control device is configured to control said actuator device based on a detection of said sensor unit to vary orientation of each capsule so that the capsule reaches said cutting arrangement with a desired orientation with respect to said cutting arrangement.

29. Apparatus according to claim 24, wherein said feeding device includes a carousel that is rotatable about a carousel rotation axis and is arranged to support said at least one feeding unit, said motor unit being configured to rotate said carousel around said carousel rotation axis, said apparatus including a motion transmitting arrangement with one or more gears configured to connect said carousel rotation axis with said spindle rotation axis.

30. Apparatus according to claim 24, wherein said support is configured to engage the capsule with a suction holding member; said support being configured to engage an external surface of the capsule facing downwards.
